(19) United States
(12) Patent Application Publication
(10) Pub. No.: US 2026/0011987 A1
(43) Pub. Date: Jan. 8, 2026

(54) HOUSING OF POWER SUPPLY AND STRUCTURAL COLUMN THEREOF

(71) Applicant: CHANNEL WELL TECHNOLOGY CO., LTD., Taoyuan City (TW)

(72) Inventors: YEN-CHENG PAN, Taoyuan City (TW); CHIA-YING LIN, Taoyuan City (TW)

(73) Assignee: CHANNEL WELL TECHNOLOGY CO., LTD., Taoyuan City (TW)

(21) Appl. No.: 18/809,308

(22) Filed: Aug. 19, 2024

(30) Foreign Application Priority Data
Jul. 5, 2024 (TW) 113125202

(51) Int. Cl. H02B 1/30

(52) U.S. Cl. CPC H02B 1/30

(57) ABSTRACT

A structural column of a housing applied to a power supply includes a column body and two engagement portions. The column body extends along a height direction, and the two engagement portions are respective disposed on a first side and a second side of the column body. Both of the first side and the second side are perpendicular to the height direction, an included angle between the first side and the second side is 90 degrees, and the two engagement portions respectively protrudes or recess from surfaces of the first side and the second side. The present disclosure further provides a housing of power supply, the housing including: a base bottom wall, an upper cover, a plurality of detachable sidewalls and at least one structural column.

### CROSS-REFERENCE TO RELATED APPLICATION

This non-provisional application claims priority under 35 U.S.C. § 119 (a) on Patent Application No(s). 113125202 filed in Taiwan, R.O.C. on Jul. 5, 2024, the entire contents of which are hereby incorporated by reference.

### BACKGROUND OF THE INVENTION

### 1. Field of the Invention

The present disclosure relates to a power supply of a computer, and in particular to a housing of a power supply and a structural column thereof.

### 2. Description of the Related Art

A power supply of a computer is capable of transforming and rectifying an alternating current to power a hard drive, an optical drive and a motherboard in the computer. In a conventional power supply of a computer, for example, as shown in FIG. 2 of Taiwan Patent Publication No. 580173, the structure of a housing is usually separated into an upper cover and a lower cover as assemblies of a total of two modules, and forms a hexahedral structure. Wall surfaces of such hexahedral structure, and sidewalls in particular, lack variations for further utilization.

### BRIEF SUMMARY OF THE INVENTION

In order to solve various problems of the housing of the power supply of the prior art, the present invention proposes a housing of a power supply a structural column thereof.

To achieve the above and other objects, the present disclosure provides a structural column applied to a housing of a power supply. The housing of a power supply includes: a column body, extending along a height direction; and the two engagement portions, respectively disposed on a first side and a second side of the column body, both of the first side and the second side being perpendicular to the height direction, an included angle between the first side and the second side being 90 degrees, and the two engagement portions respectively protruding or recessing from surfaces of the first side and the second side.

In one embodiment of the present disclosure, the column body is provided with a rounded corner, which is located on an opposite corner of an intersection of the first side and the second side.

In one embodiment of the present disclosure, the column body is provided with a lock hole on each of both ends along the height direction.

In one embodiment of the present disclosure, the structural column is made of a transparent material.

The present disclosure further provides a housing of a power supply. The housing includes: a base bottom wall; an upper cover, disposed opposite to the base bottom wall; a plurality of detachable sidewalls, surrounding the base bottom wall; and the structural column described above, disposed between two detachable sidewalls of the plurality of detachable walls, wherein the two engagement portions of the structural column are respectively engaged with the two detachable sidewalls.

In one embodiment of the present disclosure, at least one base sidewall is further included, and the plurality of detachable sidewalls and the at least one base sidewall surround the base bottom wall.

In one embodiment of the present disclosure, the structural column is individually connected to the upper cover and the base bottom wall by means of locking.

In one embodiment of the present disclosure, the plurality of detachable sidewalls are made of a transparent material.

In one embodiment of the present disclosure, the plurality of detachable sidewalls are made of an aluminum material.

Thus, the housing of a power supply and the structural column thereof allow wall surfaces of the housing of the power supply to be detachable, and thus variations can be made to the detachable sidewalls for further utilization.

### BRIEF DESCRIPTION OF THE DRAWINGS

FIG. 1 is a perspective schematic diagram of a structural column applied to a housing of a power supply according to a first embodiment of the present disclosure.

FIG. 2 is a plan view of a structural column applied to a housing of a power supply according to the first embodiment of the present disclosure.

FIG. 3 is a perspective schematic diagram applied to a housing of a power supply according to the first embodiment of the present disclosure.

FIG. 4 is an exploded diagram of a housing of a power supply according to the first embodiment of the present disclosure.

FIG. 5A is a top view of engagement portions according to the first embodiment of the present disclosure.

FIG. 5B is a top view of engagement portions according to a second embodiment of the present disclosure.

### DETAILED DESCRIPTION OF THE INVENTION

To fully understand the present disclosure, the present disclosure is described in detail by way specific embodiments with the accompanying drawings below. A person skilled in the art would be able to understand the objects, features and effects of the present disclosure on the basis of the disclosure of the present application. It should be noted that, the present disclosure is may be implemented or applied by other specific embodiments, and changes and modifications may also be made on the basis of different perspectives and applications to various details in the description without departing from the spirit of the present disclosure. Technical contents associated with the present disclosure are described in detail below, and it should be noted that the disclosure is not to be construed as limitations to the scope of claims of the present disclosure. Associated details are as given in the description below.

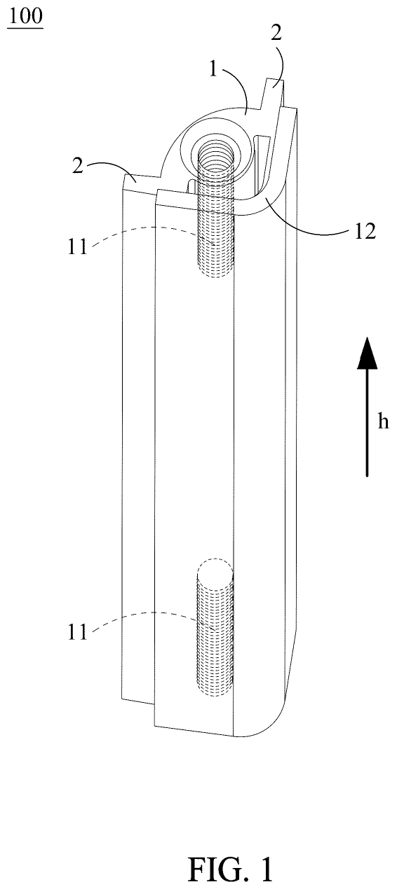

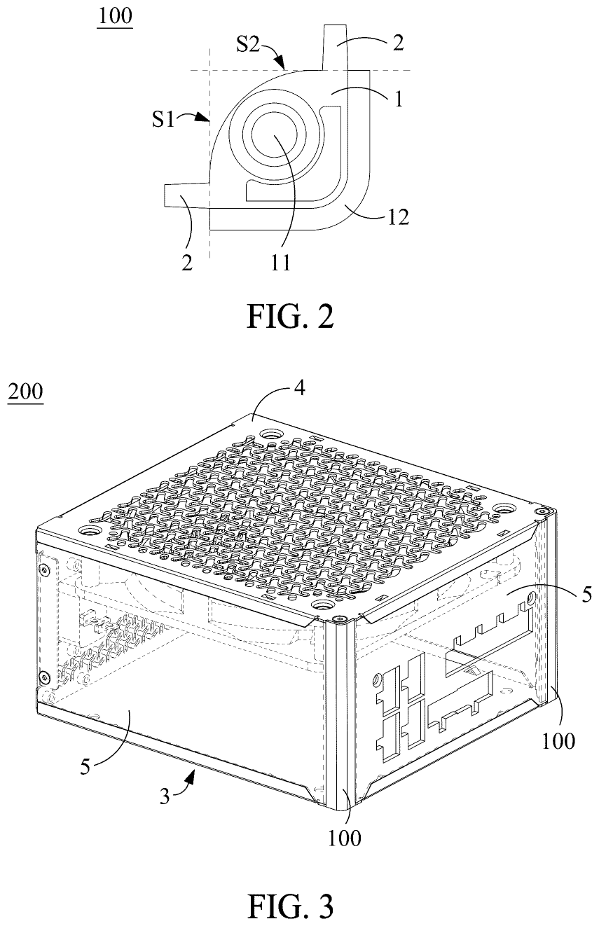

As shown in FIG. 1 and FIG. 2, a structural column 100 applied to a housing 200 of a power supply according to an embodiment of the present disclosure includes a column body 1 and two engagement portions 2.

The column body 1 extends along a height direction h. The shape and material of the column body 1 are not specifically defined, and are preferably a slender and elongated shape (with a longest side along the height direction h) and a light and firm material.

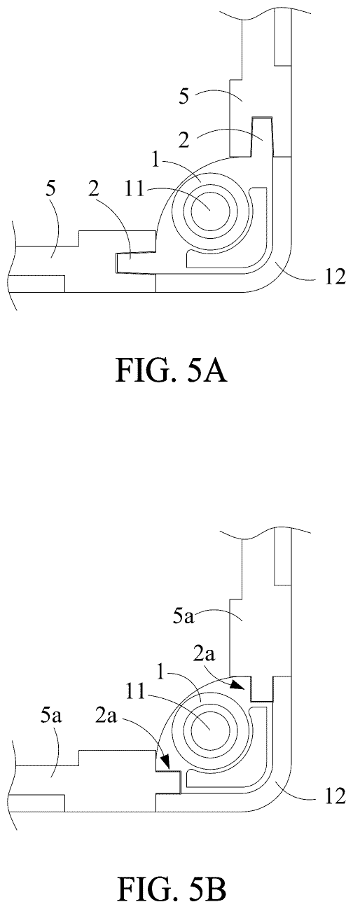

The two engagement portions 2 are respective disposed on a first side S1 and a second side S2 of the column body 1. Both of the first side S1 and the second side S2 are perpendicular to the height direction h, an included angle between the first side S1 and the second side S2 is 90 degrees, and the two engagement portions 2 respectively protrude or recess from surfaces of the first side S1 and the second side S2. FIG. 1 and FIG. 2 show situations where the two engagement portions 2 respectively extend from the surfaces of the first side S1 and the second side S2. Referring to FIG. 5A, the two engagement portions 2 can be used to engaged with detachable sidewalls 5 of the housing 200 of the power supply above. In another embodiment, referring to FIG. 5B, the two engagement portions 2a can recess respectively from the surfaces of the first side S1 and the second side S2, and can be similarly used to fasten with the detachable sidewalls 5a of the housing 200 of the power supply above. That is to say, the shape of the two engagement portions is not specifically defined, provided that an engagement function can be achieved by relative relief on the surfaces of the first side S1 and the second side S2.

With the structural column 100 of the present disclosure, the wall surfaces of the housing 200 of the power supply can become detachable (as the detachable sidewalls 5), and variations can be made to the detachable sidewalls 5 for further utilization. For example, one or a plurality of the detachable sidewalls 5 can be made of an aluminum material instead so as to increase heat dissipation of the power supply to an exterior. The aluminum material used can be presented in a variety of colors and diverse appearances such as bright surfaces or matte surfaces by means of anodization. Alternatively, the detachable sidewalls 5 can be made of a transparent material or a semi-transparent material, so as to be able to observe conditions of the power supply. Alternatively, light or decorative objects (to change light propagation) for guiding light can be added to the detachable sidewalls 5 to attract consumers to make a purchase, hence enhancing product competitiveness. The detachable sidewalls 5 can also allow the housing 200 of the power supply to be separately detachable in a specific direction, so as to better facilitate maintenance and repair within a narrow space of a computer host.

Further, in one embodiment of the present disclosure, the column body 1 is provided with a rounded corner 12, which is located on an opposite corner of an intersection of the first side S1 and the second side S2. The rounded corner 12 is a corner facing outward when the column body 1 is completely installed, and the form of such rounded corner protects elements from damage and thus prevents a user from injuries.

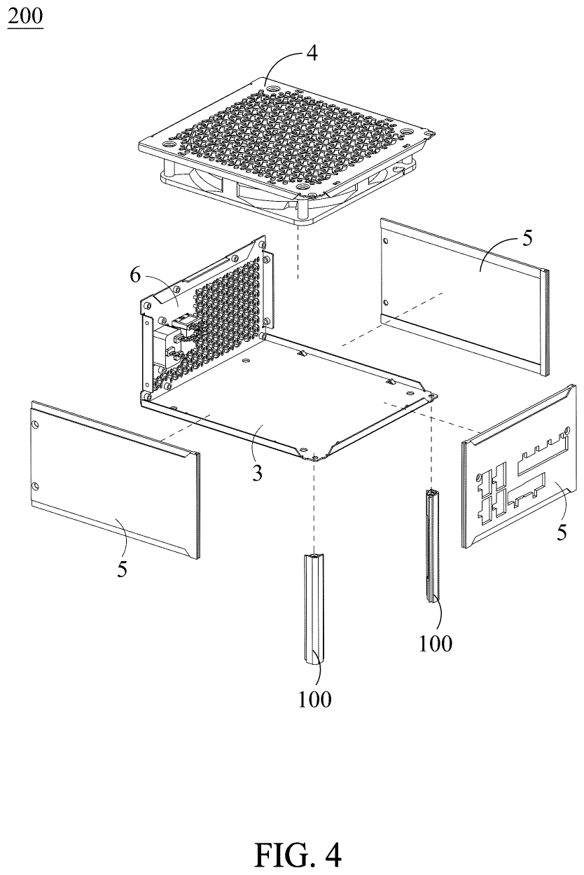

Further, in this embodiment, the column body 1 is provided with a lock hole 11 on each of both ends along the height direction h, and the lock holes 11 can be used to lock a base bottom wall 3 and an upper cover 4 (referring to FIG. 3 and FIG. 4) of the housing 200 of the power supply above. However, the present disclosure is not limited to the examples above. The structural column 100 can be coupled with the base bottom wall 3 and the upper cover 4 by engagement or mechanisms practicing other mechanical principles.

Further, in this embodiment, the structural column 100 is made of a transparent material, for example, transparent plastic. However, the present disclosure is not limited to the examples above. In other embodiments, the structural column 100 can be made of opaque plastic or a metal material, for example.

Referring to FIG. 3 and FIG. 4, the present disclosure further provides the housing 200 of a power supply. The housing 200 includes the base bottom wall 3, the upper cover 4, the plurality of detachable sidewalls 5 and at least one structural column 100.

The upper cover 4 is disposed opposite to the base bottom wall 3, and the plurality of detachable sidewalls 5 surround the base bottom wall 3 to form an accommodating space for placing components such as a power source, a circuit board and a fan (not shown).

The structural column 100 is disposed between two detachable sidewalls 5 of the plurality of detachable sidewalls 5. Referring to FIG. 5A and FIG. 5B, the two engagement portions 2 of the structural column 100 can be respectively engaged with the two detachable sidewalls 5 so as to securely connect the detachable sidewalls 5.

Further, in this embodiment, the housing 200 of the power supply further includes at least one base sidewall 6, and the plurality of detachable sidewalls 5 and the base sidewall 6 surround the base bottom wall 3. FIG. 3 and FIG. 4 show one base sidewall 6 and three detachable sidewalls 5, and two structural columns 100 are respectively connected between two adjacent detachable sidewalls 5. However, the present disclosure is not limited to the examples above. In other embodiments, two base sidewalls 6 and two detachable sidewalls 5 can be provided instead, and one structural column 100 is connected between the two detachable sidewalls 5. Alternatively, the housing 200 of the power supply does not include the base sidewall 6, and has four surfaces thereof as the detachable sidewalls 5. Accordingly, each of four structural columns 100 is connected between every two adjacent detachable sidewalls 5.

The base sidewall 6 can be formed integrally at the base bottom wall 3 or the upper cover 4, or be connected to the base bottom wall 3 or the upper cover 4 by other mechanisms. The base sidewall 6 and the detachable sidewalls 5 can also be connected by means of locking or engagement.

Further, in this embodiment of the present disclosure, the structural column 100 is individually connected to the upper cover 4 and the base bottom wall 3 by means of locking. The column body 1 of the structural column 100 is provided with a lock hole 11 on each of both ends along the height direction h, and the lock holes 11 can be used to lock the base bottom wall 3 and the upper cover 4.

Further, in this embodiment, the detachable sidewalls 5 are made of a transparent material, for example, transparent plastic. The advantages of the detachable sidewalls 5 made as being transparent or semi-transparent are as described above, and are omitted herein.

The present invention is described by way of the embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A structural column applied to a housing of a power supply, the structural column comprising:
a column body, extending along a height direction; and
two engagement portions, respectively disposed on a first side and a second side of the column body, both of the first side and the second side being perpendicular to the height direction, an included angle between the first side and the second side being 90 degrees, and the two engagement portions respectively protruding or recessing from surfaces of the first side and the second side.

2. The structural column according to claim 1, wherein the column body is provided with a rounded corner, which is located on an opposite corner of an intersection of the first side and the second side.

3. The structural column according to claim 1, wherein the column body is provided with a lock hole on each of both ends along the height direction.

4. The structural column according to claim 1, wherein the structural column is made of a transparent material.

5. A housing of a power supply, comprising:
a base bottom wall;
an upper cover, disposed opposite to the base bottom wall;
a plurality of detachable sidewalls, surrounding the base bottom wall; and
the structural column according to claim 1, disposed between two detachable sidewalls of the plurality of detachable sidewalls, wherein the two engagement portions of the structural column are respectively engaged with the two detachable sidewalls.

6. The housing of a power supply according to claim 5, further comprising at least one base sidewall, wherein the plurality of detachable sidewalls and the at least one base sidewall surround the base bottom wall.

7. The housing applied to a power supply according to claim 5, wherein the structural column is individually connected to the upper cover and the base bottom wall by means of locking.

8. The housing applied to a power supply according to claim 5, wherein the plurality of detachable sidewalls are made of a transparent material.

9. The housing applied to a power supply according to claim 5, wherein the plurality of detachable sidewalls are made of an aluminum material.
